(19) United States
(12) Patent Application Publication
(10) Pub. No.: US 2026/0147099 A1
(43) Pub. Date: May 28, 2026

(54) SENSING SYSTEM, SENSING CONTROL DEVICE, AND SENSING METHOD

(71) Applicant: Sony Semiconductor Solutions Corporation, Kanagawa (JP)

(72) Inventors: Takayoshi Ozone, Kanagawa (JP); Seiji Kayashima, Kanagawa (JP)

(21) Appl. No.: 19/123,326

(22) PCT Filed: Oct. 23, 2023
(86) PCT No.: PCT/JP2023/038166

§ 371 Date: Apr. 22, 2025

(30) Foreign Application Priority Data
Nov. 8, 2022 (JP) 2022-178860

(51) Int. Cl. G01S 7/486; G01S 7/484; G01S 7/4863; G01S 17/89; G01S 17/931; H04N 25/531

(52) U.S. Cl. CPC G01S 7/4868; G01S 7/484; G01S 7/4863; G01S 17/89; G01S 17/931; H04N 25/531

(57) ABSTRACT

Sensing systems, methods and devices are disclosed. In one example, a sensing system comprises a first imaging sensor including an array of light receiving elements and a first light emitter including an array of light emitting elements. Control circuitry is configured to control the first imaging sensor and the first light emitter such that an imaging range of a subset of the array of light receiving elements overlaps with an irradiation range of a subset of the array of light emitting elements.

### TECHNICAL FIELD

The present technology relates to a sensing system, a sensing control device, and a sensing method, and more particularly, to a sensing system, a sensing control device, and a sensing method suitable for use in a case where a rolling shutter image sensor is used.

### CROSS REFERENCE TO RELATED APPLICATIONS

This application claims the benefit of Japanese Priority Patent Application JP 2022-178860 filed on Nov. 8, 2022, the entire contents of which are incorporated herein by reference.

### BACKGROUND ART

In recent years, various sensors such as a camera and a light detection and ranging or laser imaging detection and ranging (LiDAR) are provided in a vehicle in order to monitor surroundings of the vehicle. As one of such sensors, for example, a device in which a rotary LiDAR and a rolling shutter camera are combined has been proposed (See, for example, PTL 1.).

Furthermore, in order to improve the sensing capability in an environment where the surroundings are dark such as at night, an infrared camera including an image sensor including an imaging element capable of detecting infrared rays and a light emitting unit capable of emitting illumination light including infrared (IR) light may be used.

### CITATION LIST

### Patent Literature

PTL 1: JP 2021-105611A

### SUMMARY OF INVENTION

### Technical Problem

For example, in a case where the imaging element of the infrared camera is a rolling shutter type, if the light emitting unit is caused to emit light at all times, illumination light is irradiated even in a period (Hereinafter, referred to as a non-exposure period.) other than an exposure period of each line of the imaging element. Therefore, the utilization efficiency of the light emitting unit (illumination light) decreases and the power consumption increases.

On the other hand, when the exposure period of the light emitting unit is simply shortened in order to improve the utilization efficiency of the light emitting unit, since the exposure period of each line of the imaging element is shifted, variation occurs in the time during which the illumination light is irradiated in the exposure period of each line of the imaging element. As a result, for example, noise such as lateral stripes may occur in a captured image.

The present technology has been made in view of such a situation, and aims to improve the utilization efficiency of the light emitting unit in a case where the rolling shutter image sensor is used.

### Solution to Problem

Sensing systems, methods and devices are disclosed. In one example, a sensing system comprises a first imaging sensor including an array of light receiving elements and a first light emitter including an array of light emitting elements. Control circuitry is configured to control the first imaging sensor and the first light emitter such that an imaging range of a subset of the array of light receiving elements overlaps with an irradiation range of a subset of the array of light emitting elements.

A sensing system according to a first aspect of the present technology includes: a first image sensor that controls exposure for each line; a first light emitting unit whose irradiation range overlaps at least a part of an imaging range of the first image sensor and whose light emission timing can be controlled for each line; and a control unit that integrally controls the first image sensor and the first light emitting unit.

A sensing control device according to a second aspect of the present technology includes a control unit that integrally controls a first image sensor that controls exposure for each line and a light emitting unit whose irradiation range overlaps at least a part of the imaging range of the image sensor and whose light emission timing can be controlled for each line.

A sensing method according to a second aspect of the present technology includes integrally controlling a first image sensor that controls exposure for each line and a light emitting unit whose irradiation range overlaps at least a part of an imaging range of the image sensor and whose light emission timing can be controlled for each line.

In the first aspect of the present technology, the first image sensor that controls exposure for each line, and the first light emitting unit whose irradiation range overlaps at least a part of an imaging range of the first image sensor and whose light emission timing can be controlled for each line are integrally controlled.

In the second aspect of the present technology, the first image sensor that controls exposure for each line and the light emitting unit whose irradiation range overlaps at least a part of an imaging range of the image sensor and whose light emission timing can be controlled for each line are integrally controlled.

According to another aspect of the present technology, a sensing system comprises a first imaging sensor including an array of light receiving elements, a first light emitter including an array of light emitting elements, and control circuitry configured to control the first imaging sensor and the first light emitter such that an imaging range of a subset of the array of light receiving elements overlaps with an irradiation range of a subset of the array of light emitting elements.

The subset of the array of light receiving elements can be a number of lines in the array of light receiving elements, and the subset of the array of light emitting elements can also be a same number of lines in the array of light emitting elements. In one example, the number of lines is 1.

Additionally, the control circuitry can control an exposure timing of the first imaging sensor based upon a light emission timing of the first light emitter, or can control a light emission timing of the first light emitter based upon an exposure timing of the first imaging sensor, or can control a combination of both.

In one example, the control circuitry controls the light emission timing of each line of the array of light emitting elements to correlate to the exposure timing of each line of the array of light receiving elements. And the control circuitry can cause each line of the array of light emitting elements to emit light for a predetermined period of time in an exposure period of each line of the array of light receiving elements.

In a further example of this aspect, the sensing system also comprises a light detecting sensor including an array of light receiving elements. The control circuitry is configured to control the first light emitter to emit light in a first pattern for the light detecting sensor in a non-exposure period that is a period other than an exposure period of the first imaging sensor.

Here, the control circuitry may control a light emission timing of each line of the array of light emitting elements in accordance with the non-exposure period for each line of the array of light receiving elements in the first imaging sensor.

These aspects may also be embodied in sensing control devices, sensing methods, and computer readable media storing program code for performing corresponding operations.

### BRIEF DESCRIPTION OF DRAWINGS

FIG. 1 is a block diagram illustrating a configuration example of a vehicle control system.

FIG. 2 is a diagram illustrating an example of a sensing area.

FIG. 3 illustrates an example of a relationship between an exposure timing and a light emission timing in one frame period of a global shutter imaging element.

FIG. 4A and 4B illustrate an example of a relationship between an exposure timing and a light emission timing in one frame period of a rolling shutter imaging element.

FIG. 5 illustrates another example of a relationship between an exposure timing and a light emission timing in one frame period of the rolling shutter imaging element.

FIG. 6 is a block diagram of a first embodiment of a sensing system to which the present technology is applied.

FIG. 7 illustrates a configuration example of a VCSEL.

FIG. 8 is a diagram illustrating a scanning method of a light emitting unit.

FIG. 9 is a timing chart illustrating an operation example of the sensing system in FIG. 6.

FIG. 10 is a diagram illustrating an example of installation positions of a camera and a LiDAR.

FIG. 11 is a block diagram of a second embodiment of a sensing system to which the present technology is applied.

FIG. 12 is a diagram illustrating a configuration example of hardware of a sensing unit.

FIG. 13 is a diagram illustrating an example of an installation position of the sensing system in FIG. 11.

FIG. 14 is a timing chart illustrating an operation example of the sensing system in FIG. 11.

FIG. 15 is a block diagram of a third embodiment of a sensing system to which the present technology is applied.

FIG. 16 is a diagram illustrating an example of an imaging range of an image sensor of the sensing system in FIG. 15.

FIG. 17 is a timing chart illustrating an operation example of the sensing system in FIG. 15.

### DESCRIPTION OF EMBODIMENTS

Hereinafter, modes for carrying out the present technology will be described. Note that the description will be given in the following order.
1. Configuration example of vehicle control system
2. Background of present technology
3. First embodiment
4. Second embodiment
5. Third embodiment
6. Modification example
7. Others

### 1. Configuration Example of Vehicle Control System

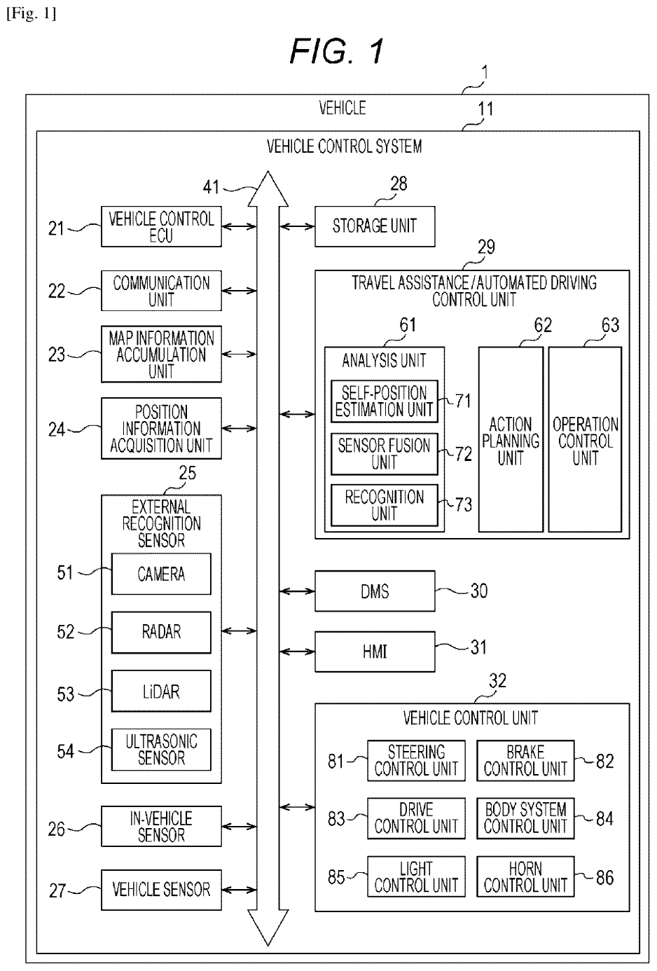

FIG. 1 is a block diagram illustrating a configuration example of a vehicle control system 11, which is an example of a mobile device control system to which the present technology is applied.

The vehicle control system 11 is provided in a vehicle 1 and performs processing related to travel assistance and automated driving of the vehicle 1.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a travel assistance/automated driving control unit 29, a driver monitoring system (DMS) 30, a human machine interface (HMI) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance/automated driving control unit 29, the driver monitoring system (DMS) 30, the human machine interface (HMI) 31, and the vehicle control unit 32 are communicably connected to each other via a communication network 41. The communication network 41 includes, for example, an in-vehicle communication network, a bus, or the like conforming to a digital bidirectional communication standard such as a controller area network (CAN), a local interconnect network (LIN), a local area network (LAN), FlexRay (registered trademark), or Ethernet (registered trademark). The communication network 41 may be selectively used depending on the type of data to be transmitted. For example, the CAN may be applied to data related to vehicle control, and the Ethernet may be applied to large-capacity data. Note that each unit of the vehicle control system 11 may be directly connected not via the communication network 41 but by, for example, wireless communication that assumes communication at a relatively short distance, such as near field communication (NFC) or Bluetooth (registered trademark).

Note that, hereinafter, in a case where each unit of the vehicle control system 11 performs communication via the communication network 41, description of the communication network 41 is omitted. For example, in a case where the vehicle control ECU 21 and the communication unit 22 perform communication via the communication network 41, it is simply described that the vehicle control ECU 21 and the communication unit 22 perform communication.

The vehicle control ECU 21 includes, for example, various processors such as a central processing unit (CPU) and a micro processing unit (MPU). The vehicle control ECU 21 controls the entire or partial function of the vehicle control system 11.

The communication unit 22 communicates with various devices inside and outside the vehicle, other vehicles, servers, base stations, and the like, and transmits and receives various data. At this time, the communication unit 22 can perform communication using a plurality of communication schemes.

Communication with the outside of the vehicle executable by the communication unit 22 will be schematically described. The communication unit 22 communicates with a server (hereinafter, the server is referred to as an external server) or the like existing on an external network via a base station or an access point by, for example, a wireless communication method such as fifth generation mobile communication system (5G), long term evolution (LTE), dedicated short range communications (DSRC), or the like. The external network with which the communication unit 22 performs communication is, for example, the Internet, a cloud network, a network unique to a company, or the like. A communication scheme performed by the communication unit 22 with respect to the external network is not particularly limited as long as it is a wireless communication scheme capable of performing digital bidirectional communication at a communication speed higher than or equal to a predetermined speed and at a distance longer than or equal to a predetermined distance.

Furthermore, for example, the communication unit 22 can communicate with a terminal existing in the vicinity of a host vehicle using a peer to peer (P2P) technology. A terminal present in the vicinity of the host vehicle is, for example, a terminal worn by a moving body moving at a relatively low speed such as a pedestrian or a bicycle, a terminal installed in a store or the like with a position fixed, or a machine type communication (MTC) terminal. Moreover, the communication unit 22 can also perform V2X communication. The V2X communication refers to, for example, communication between the host vehicle and another vehicle, such as vehicle to vehicle communication with another vehicle, vehicle to infrastructure communication with a roadside device or the like, vehicle to home communication, and vehicle to pedestrian communication with a terminal or the like possessed by a pedestrian.

For example, the communication unit 22 can receive a program for updating software for controlling the operation of the vehicle control system 11 from the outside (Over The Air). The communication unit 22 can further receive map information, traffic information, information around the vehicle 1, and the like from the outside. Furthermore, for example, the communication unit 22 can transmit information regarding the vehicle 1, information around the vehicle 1, and the like to the outside. Examples of the information regarding the vehicle 1 transmitted to the outside by the communication unit 22 include, for example, data indicating the state of the vehicle 1, a recognition result by a recognition unit 73, and the like. Moreover, for example, the communication unit 22 performs communication corresponding to a vehicle emergency call system such as an eCall.

For example, the communication unit 22 receives an electromagnetic wave transmitted by a road traffic information communication system (vehicle information and communication system (VICS) (registered trademark)), such as a radio wave beacon, an optical beacon, or FM multiplex broadcasting.

Communication with the inside of the vehicle executable by the communication unit 22 will be schematically described. The communication unit 22 can communicate with each device in the vehicle using, for example, wireless communication. The communication unit 22 can perform wireless communication with an in-vehicle device by a communication scheme capable of performing digital bidirectional communication at a predetermined communication speed or higher by wireless communication, such as wireless LAN, Bluetooth, NFC, or wireless USB (WUSB), for example. It is not limited thereto, and the communication unit 22 can also communicate with each device in the vehicle using wired communication. For example, the communication unit 22 can communicate with each device in the vehicle by wired communication via a cable connected to a connection terminal which is not illustrated. The communication unit 22 can communicate with each device in the vehicle by a communication scheme capable of performing digital bidirectional communication at a predetermined communication speed or higher by wired communication, such as universal serial bus (USB), high-definition multimedia interface (HDMI) (registered trademark), or mobile high-definition link (MHL).

Here, the device in the vehicle refers to, for example, a device that is not connected to the communication network 41 in the vehicle. As the device in the vehicle, for example, a mobile device or a wearable device carried by an occupant such as a driver or the like, an information device brought into the vehicle and temporarily installed, or the like is assumed.

The map information accumulation unit 23 accumulates one or both of a map acquired from the outside and a map created by the vehicle 1. For example, the map information accumulation unit 23 accumulates a three-dimensional high-precision map, a global map having lower accuracy than the high-precision map and covering a wide area, and the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from an external server or the like. The point cloud map is a map including point clouds (point cloud data). The vector map is, for example, a map in which traffic information such as a lane and a position of a traffic light is associated with a point cloud map and adapted to an advanced driver assistance system (ADAS) or autonomous driving (AD).

The point cloud map and the vector map may be provided from, for example, an external server or the like, or may be created by the vehicle 1 as a map for performing matching with a local map to be described later on the basis of a sensing result by a camera 51, a radar 52, a LiDAR 53, or the like, and may be accumulated in the map information accumulation unit 23. Furthermore, in a case where a high-precision map is provided from an external server or the like, for example, map data of several hundred meters square regarding a planned route on which the vehicle 1 travels from now is acquired from the external server or the like in order to reduce the communication capacity.

The position information acquisition unit 24 receives a global navigation satellite system (GNSS) signal from a GNSS satellite, and acquires position information of the vehicle 1. The acquired position information is supplied to the travel assistance/automated driving control unit 29. Note that the position information acquisition unit 24 is not limited to a method using the GNSS signal, and may acquire the position information using, for example, a beacon.

The external recognition sensor 25 includes various sensors used for recognizing an external situation of the vehicle 1, and supplies sensor data from each sensor to each part of the vehicle control system 11. Any type and number of sensors included in the external recognition sensor 25 may be adopted.

For example, the external recognition sensor 25 includes a camera 51, a radar 52, a light detection and ranging or laser imaging detection and ranging (LiDAR) 53, and an ultrasonic sensor 54. It is not limited thereto, and the external recognition sensor 25 may include one or more types of sensors among the camera 51, the radar 52, the LiDAR 53, and the ultrasonic sensor 54. The numbers of the cameras 51, the radars 52, the LiDAR 53, and the ultrasonic sensors 54 are not particularly limited as long as they can be practically installed in the vehicle 1. Furthermore, the type of sensor included in the external recognition sensor 25 is not limited to this example, and the external recognition sensor 25 may include another type of sensor. An example of the sensing area of each sensor included in the external recognition sensor 25 will be described later.

Note that an imaging method of the camera 51 is not particularly limited. For example, cameras of various imaging methods such as a time-of-flight (ToF) camera, a stereo camera, a monocular camera, and an infrared camera, which are imaging methods capable of distance measurement, can be applied to the camera 51 as necessary. It is not limited thereto, and the camera 51 may simply acquire a captured image regardless of distance measurement.

Furthermore, for example, the external recognition sensor 25 can include an environment sensor for detecting the environment for the vehicle 1. The environment sensor is a sensor for detecting an environment such as weather, climate, and brightness, and can include various sensors such as a raindrop sensor, a fog sensor, a sunshine sensor, a snow sensor, and an illuminance sensor, for example.

Moreover, for example, the external recognition sensor 25 includes a microphone used for detecting a sound around the vehicle 1, a position of a sound source, and the like.

The in-vehicle sensor 26 includes various sensors for detection of information inside the vehicle, and supplies sensor data from each sensor to each unit of the vehicle control system 11. The type and number of various sensors included in the in-vehicle sensor 26 are not particularly limited as long as they are types and numbers that can be practically installed in the vehicle 1.

For example, the in-vehicle sensor 26 can include one or more sensors of a camera, a radar, a seating sensor, a steering wheel sensor, a microphone, and a biological sensor. As the camera included in the in-vehicle sensor 26, for example, cameras of various imaging methods capable of measuring a distance, such as a ToF camera, a stereo camera, a monocular camera, and an infrared camera, can be used. It is not limited thereto, and the camera included in the in-vehicle sensor 26 may simply acquire a captured image regardless of distance measurement. The biological sensor included in the in-vehicle sensor 26 is provided, for example, on a seat, a steering wheel, or the like, and detects various types of biological information of an occupant such as a driver.

The vehicle sensor 27 includes various sensors for detecting the state of the vehicle 1, and supplies sensor data from each sensor to each part of the vehicle control system 11. The type and number of various sensors included in the vehicle sensor 27 are not particularly limited as long as they are types and numbers that can be practically installed in the vehicle 1.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of rotations of the engine or the motor, an air pressure sensor that detects the air pressure of the tire, a slip rate sensor that detects the slip rate of the tire, and a wheel speed sensor that detects the rotation speed of the wheel. For example, the vehicle sensor 27 includes a battery sensor that detects a remaining amount and a temperature of a battery, and an impact sensor that detects an external impact.

The storage unit 28 includes at least one of a nonvolatile storage medium or a volatile storage medium, and stores data and a program. The storage unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as a storage medium. The storage unit 28 stores various programs and data used by each unit of the vehicle control system 11. For example, the storage unit 28 includes an event data recorder (EDR) and a data storage system for automated driving (DSSAD), and stores information of the vehicle 1 before and after an event such as an accident and information acquired by the in-vehicle sensor 26.

The travel assistance/automated driving control unit 29 controls travel assistance and automated driving of the vehicle 1. For example, the travel assistance/automated driving control unit 29 includes an analysis unit 61, an action planning unit 62, and an operation control unit 63.

The analysis unit 61 analyzes the vehicle 1 and a situation of the surroundings. The analysis unit 61 includes a self-position estimation unit 71, a sensor fusion unit 72, and the recognition unit 73.

The self-position estimation unit 71 estimates a self-position of the vehicle 1 on the basis of sensor data from the external recognition sensor 25 and a high-precision map accumulated in the map information accumulation unit 23. For example, the self-position estimation unit 71 generates a local map on the basis of sensor data from the external recognition sensor 25, and estimates the self-position of the vehicle 1 by matching the local map with the high-precision map. The position of the vehicle 1 is based on, for example, the center of a rear wheel-to-axle.

The local map is, for example, a three-dimensional high-precision map created using a technology such as simultaneous localization and mapping (SLAM), or the like, an occupancy grid map, or the like. The three-dimensional high-precision map is, for example, the above-described point cloud map or the like. The occupancy grid map is a map in which a three-dimensional or two-dimensional space around the vehicle 1 is divided into grids (lattices) of a predetermined size, and an occupancy state of an object is indicated in units of grids. The occupancy state of the object is indicated by, for example, the presence or absence or existence probability of the object. The local map is also used for detection processing and recognition processing of a situation outside the vehicle 1 by the recognition unit 73, for example.

Note that the self-position estimation unit 71 may estimate the self-position of the vehicle 1 on the basis of the position information acquired by the position information acquisition unit 24 and the sensor data from the vehicle sensor 27.

The sensor fusion unit 72 performs sensor fusion processing to obtain new information by combining a plurality of different types of sensor data (for example, image data supplied from the camera 51 and sensor data supplied from the radar 52). Methods for combining different types of sensor data include integration, fusion, association, and the like.

The recognition unit 73 executes detection processing for detecting a situation outside the vehicle 1 and recognition processing for recognizing a situation outside the vehicle 1.

For example, the recognition unit 73 performs detection processing and recognition processing of the external situation of the vehicle 1 on the basis of information from the external recognition sensor 25, information from the self-position estimation unit 71, information from the sensor fusion unit 72, and the like.

Specifically, for example, the recognition unit 73 performs detection processing, recognition processing, and the like of an object around the vehicle 1. The detection processing of an object is, for example, processing of detecting presence or absence, size, shape, position, movement, and the like of an object. The recognition processing of an object is, for example, processing of recognizing an attribute such as a type of an object or the like or identifying a specific object. However, the detection processing and the recognition processing are not always clearly separated and may overlap.

For example, the recognition unit 73 detects an object around the vehicle 1 by performing clustering to classify point clouds based on sensor data by the radar 52, the LiDAR 53, or the like into clusters of point clouds. Thus, the presence or absence, size, shape, and position of the object around the vehicle 1 are detected.

For example, the recognition unit 73 detects a motion of the object around the vehicle 1 by performing tracking that follows a motion of the cluster of point clouds classified by clustering. Thus, the speed and the traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and the like on the basis of the image data supplied from the camera 51. Furthermore, the recognition unit 73 may recognize the type of the object around the vehicle 1 by performing recognition processing such as semantic segmentation.

For example, the recognition unit 73 can perform recognition processing of traffic rules around the vehicle 1 on the basis of a map accumulated in the map information accumulation unit 23, an estimation result of the self-position by the self-position estimation unit 71, and a recognition result of an object around the vehicle 1 by the recognition unit 73. Through this processing, the recognition unit 73 can recognize the position and the state of the traffic light, the contents of the traffic sign and the road sign, the contents of the traffic regulation, the travelable lane, and the like.

For example, the recognition unit 73 can perform recognition processing of the environment around the vehicle 1. As the surrounding environment to be recognized by the recognition unit 73, weather, temperature, humidity, brightness, road surface conditions, and the like are assumed.

The action planning unit 62 creates an action plan for the vehicle 1. For example, the action planning unit 62 creates an action plan by performing route planning and route following processing.

Note that the route planning (global path planning) is processing of planning a rough route from a start to a goal. This route planning is called a trajectory plan, and includes processing of performing a local path planning that enables safe and smooth traveling in the vicinity of the vehicle 1 in consideration of the motion characteristics of the vehicle 1 in the planned route.

Route following is processing of planning an operation for safely and accurately traveling a route planned by the route planning within a planned time. For example, the action planning unit 62 can calculate the target speed and the target angular velocity of the vehicle 1 based on a result of the route following processing.

The operation control unit 63 controls operation of the vehicle 1 in order to achieve the action plan created by the action planning unit 62.

For example, the operation control unit 63 controls a steering control unit 81, a brake control unit 82, and a drive control unit 83 included in the vehicle control unit 32 to be described later, and performs acceleration and deceleration control and direction control so that the vehicle 1 travels on the trajectory calculated by the trajectory planning. For example, the operation control unit 63 performs cooperative control for the purpose of implementing the functions of the ADAS such as collision avoidance or impact mitigation, follow-up traveling, vehicle speed maintaining traveling, collision warning of the host vehicle, lane deviation warning of the host vehicle, and the like. For example, the operation control unit 63 performs cooperative control for the purpose of automated driving or the like in which the vehicle autonomously travels without depending on the operation of the driver.

The DMS 30 performs authentication processing of a driver, recognition processing of a state of the driver, and the like on the basis of sensor data from the in-vehicle sensor 26, input data input to the HMI 31 to be described later, and the like. As the state of the driver to be recognized, for example, a physical condition, a wakefulness level, a concentration level, a fatigue level, a line-of-sight direction, a drunkenness level, a driving operation, a posture, and the like are assumed.

Note that the DMS 30 may perform authentication processing for an occupant other than the driver and recognition processing for the state of the occupant. Furthermore, for example, the DMS 30 may perform recognition processing of the situation inside the vehicle on the basis of sensor data from the in-vehicle sensor 26. As the condition inside the vehicle to be a recognition target, for example, temperature, humidity, brightness, odor, and the like are assumed.

The HMI 31 inputs various data, instructions, and the like, and presents various data to the driver and the like.

The input of data through the HMI 31 will be schematically described. The HMI 31 includes an input device for a person to input data. The HMI 31 generates an input signal on the basis of data, an instruction, or the like input with an input device, and supplies the input signal to each unit of the vehicle control system 11. The HMI 31 includes, for example, an operator such as a touch panel, a button, a switch, and a lever as the input device. The present technology is not limited thereto, and the HMI 31 may further include an input device capable of inputting information by a method other than manual operation by voice, gesture, or the like. Moreover, the HMI 31 may use, for example, a remote control device using infrared rays or radio waves, or an external connection device such as a mobile device or a wearable device corresponding to the operation of the vehicle control system 11 as an input device.

Presentation of data by the HMI 31 will be schematically described. The HMI 31 generates visual information, auditory information, and tactile information for the passenger or the outside of the vehicle. Furthermore, the HMI 31 performs output control for controlling an output, output contents, an output timing, an output method, and the like of each piece of generated information. The HMI 31 generates and outputs, for example, an operation screen, a state display of the vehicle 1, a warning display, an image such as a monitor image indicating a situation around the vehicle 1, and information indicated by light as the visual information. Furthermore, the HMI 31 generates and outputs information indicated by sounds such as voice guidance, a warning sound, and a warning message, for example, as the auditory information. Moreover, the HMI 31 generates and outputs, as the tactile information, information given to the tactile sense of the passenger by, for example, force, vibration, motion, or the like.

As an output device that the HMI 31 outputs visual information, for example, a display device that presents visual information by displaying an image by itself or a projector device that presents visual information by projecting an image can be applied. Note that the display device may be a device that displays visual information in the field of view of the passenger, such as a head-up display, a transmissive display, or a wearable device having an augmented reality (AR) function, for example, in addition to a display device having a normal display. Furthermore, in the HMI 31, a display device included in a navigation device, an instrument panel, a camera monitoring system (CMS), an electronic mirror, a lamp, or the like provided in the vehicle 1 can also be used as an output device that outputs visual information.

As the output device from which the HMI 31 outputs the auditory information, for example, an audio speaker, a headphone, or an earphone can be applied.

As an output device to which the HMI 31 outputs tactile information, for example, a haptic element using a haptic technology can be applied. The haptics element is provided, for example, at a portion with which a passenger of the vehicle 1 comes into contact, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including a steering wheel and the like, an electric power steering, and the like. The steering control unit 81 includes, for example, a steering ECU that controls a steering system, an actuator that drives the steering system, and the like.

The brake control unit 82 performs detection, control, and the like of a state of a brake system of the vehicle 1. The brake system includes, for example, a brake mechanism including a brake pedal, an antilock brake system (ABS), a regenerative brake mechanism, and the like. The brake control unit 82 includes, for example, a brake ECU that controls the brake system, an actuator that drives the brake system, and the like.

The drive control unit 83 performs detection, control, and the like of a state of a drive system of the vehicle 1. The drive system includes, for example, a driving force generation device for generating a driving force such as an accelerator pedal, an internal combustion engine, a driving motor, or the like, a driving force transmission mechanism for transmitting the driving force to wheels, and the like. The drive control unit 83 includes, for example, a drive ECU that controls the drive system, an actuator that drives the drive system, and the like.

The body system control unit 84 performs detection and control of a state of a body system of the vehicle 1, and the like. The body system includes, for example, a keyless entry system, a smart key system, a power window device, a power seat, an air conditioner, an airbag, a seat belt, a shift lever, and the like. The body system control unit 84 includes, for example, a body system ECU that controls the body system, an actuator that drives the body system, and the like.

The light control unit 85 performs detection and control of states of various lights of the vehicle 1, and the like. As the lights to be controlled, for example, headlights, backlights, fog lights, turn signals, brake lights, projections, bumper displays, and the like are assumed. The light control unit 85 includes a light ECU that controls the lights, an actuator that drives the lights, and the like.

The horn control unit 86 performs detection and control of a state of a car horn of the vehicle 1, and the like. The horn control unit 86 includes, for example, a horn ECU that controls the car horn, an actuator that drives the car horn, and the like.

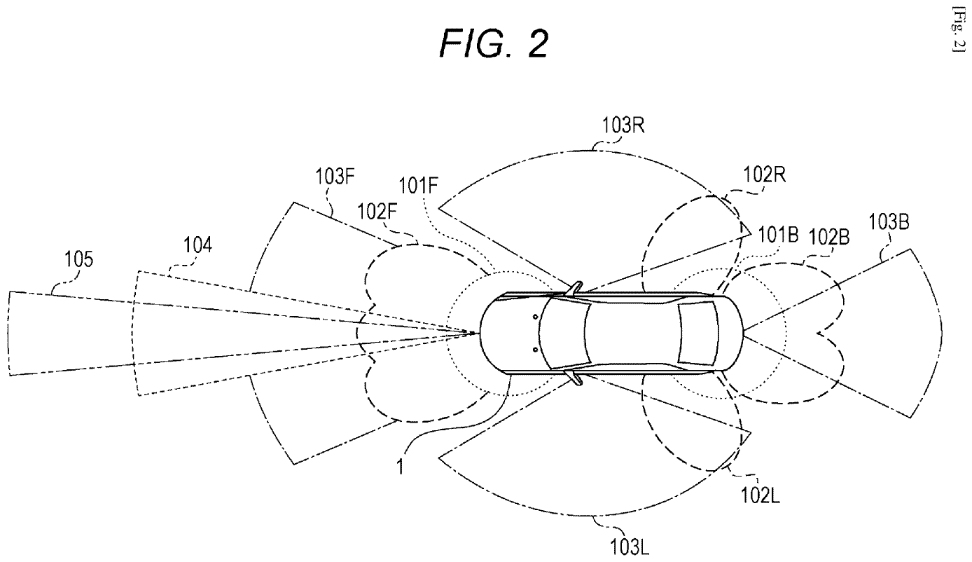

FIG. 2 is a diagram illustrating an example of a sensing area by the camera 51, the radar 52, the LiDAR 53, the ultrasonic sensor 54, and the like of the external recognition sensor 25 in FIG. 1. Note that FIG. 2 schematically illustrates the vehicle 1 as viewed from above, where a left end side is the front end (front) side of the vehicle 1 and a right end side is the rear end (rear) side of the vehicle 1.

A sensing area 101F and a sensing area 101B illustrate examples of sensing areas by the ultrasonic sensor 54. The sensing area 101F covers the periphery of the front end of the vehicle 1 by a plurality of the ultrasonic sensors 54. The sensing area 101B covers the periphery of the rear end of the vehicle 1 by the plurality of ultrasonic sensors 54.

Sensing results in the sensing area 101F and the sensing area 101B are used, for example, for parking assistance and the like of the vehicle 1.

Sensing areas 102F to 102B illustrate examples of sensing areas of the radar 52 for a short distance or a middle distance. The sensing area 102P covers a position farther than the sensing area 101F in front of the vehicle 1. The sensing area 102B covers a position farther than the sensing area 101B behind the vehicle 1. The sensing area 102L covers the rear periphery of the left side surface of the vehicle 1. The sensing area 102R covers the rear periphery of the right side surface of the vehicle 1.

A sensing result in the sensing area 102F is used, for example, to detect a vehicle, a pedestrian, or the like present in front of the vehicle 1. A sensing result in the sensing area 102B is used, for example, for a collision prevention function or the like behind the vehicle 1. Sensing results in the sensing areas 102L and 102R are used, for example, for detection of an object in a blind spot on a side of the vehicle 1, and the like.

Sensing areas 103F to 103B illustrate examples of sensing areas by the camera 51. The sensing area 103F covers a position farther than the sensing area 102F in front of the vehicle 1. The sensing area 103B covers a position farther than the sensing area 102B behind the vehicle 1. The sensing area 103L covers the periphery of the left side surface of the vehicle 1. The sensing area 103R covers the periphery of the right side surface of the vehicle 1.

A sensing result in the sensing area 103F can be used for, for example, recognition of a traffic light or a traffic sign, a lane departure prevention assist system, and an automatic headlight control system. A sensing result in the sensing area 103B can be used for, for example, parking assistance and a surround view system. Sensing results in the sensing area 103L and the sensing area 103R can be used for a surround view system, for example.

A sensing area 104 illustrates an example of a sensing area by the LiDAR 53. The sensing area 104 covers a position farther than the sensing area 103F in front of the vehicle 1. Meanwhile, the sensing area 104 has a narrower range in a left-right direction than the sensing area 103F.

A sensing result in the sensing area 104 is used, for example, for detecting an object such as a surrounding vehicle.

A sensing area 105 illustrates an example of a sensing area of the long-range radar 52. The sensing area 105 covers a position farther than the sensing area 104 in front of the vehicle 1. Meanwhile, the sensing area 105 has a narrower range in the left-right direction than the sensing area 104.

A sensing result in the sensing area 105 is used for, for example, adaptive cruise control (ACC), emergency braking, collision avoidance, and the like.

Note that the sensing areas of the respective sensors of the camera 51, the radar 52, the LiDAR 53, and the ultrasonic sensor 54 included in the external recognition sensor 25 may have various configurations other than those in FIG. 2. Specifically, the ultrasonic sensors 54 may also sense the side of the vehicle 1, or the LiDAR 53 may sense the rear of the vehicle 1. Furthermore, the installation position of each sensor is not limited to each example described above. Furthermore, the number of sensors may be one or more.

### 2. Background of Present Technology

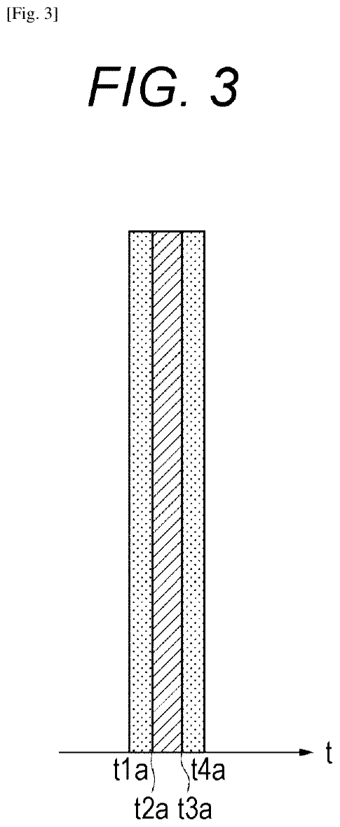

Next, the background of the present technology will be described with reference to FIGS. 3 to 5.

In the vehicle 1, for example, an imaging range is irradiated with illumination light including infrared (IR) light or the like in accordance with imaging by the camera 51 or a camera of the in-vehicle sensor 26.

FIG. 3 illustrates an example of a relationship between an exposure timing of an imaging element and a light emission timing of illumination light in one frame period in a case where the camera includes a global shutter imaging element in which exposure (scanning) of all pixels is simultaneously performed. In the drawing, a horizontal axis represents time, and a vertical axis represents a line of the imaging element.

For example, in a period from time t1a to time t4a, exposure of all pixels of the imaging element is simultaneously performed.

On the other hand, for example, in a period from time t2a to time t3a during an exposure period, the imaging range of the camera is irradiated with the illumination light. As a result, the imaging range of all the pixels of the imaging element is substantially uniformly irradiated with the illumination light.

In this example, since an irradiation period of the illumination light is shortened, power consumption by the illumination light is reduced. Furthermore, since a ratio of the irradiation period of the illumination light in the exposure period of each pixel increases, the effect of the illumination light is sufficiently exhibited even in a scene irradiated with sunlight. Moreover, rolling shutter distortion does not occur.

On the other hand, since the imaging element of the global shutter is expensive, the cost of the camera increases.

Therefore, a rolling shutter imaging element that controls exposure for each line is often used although the rolling shutter distortion occurs.

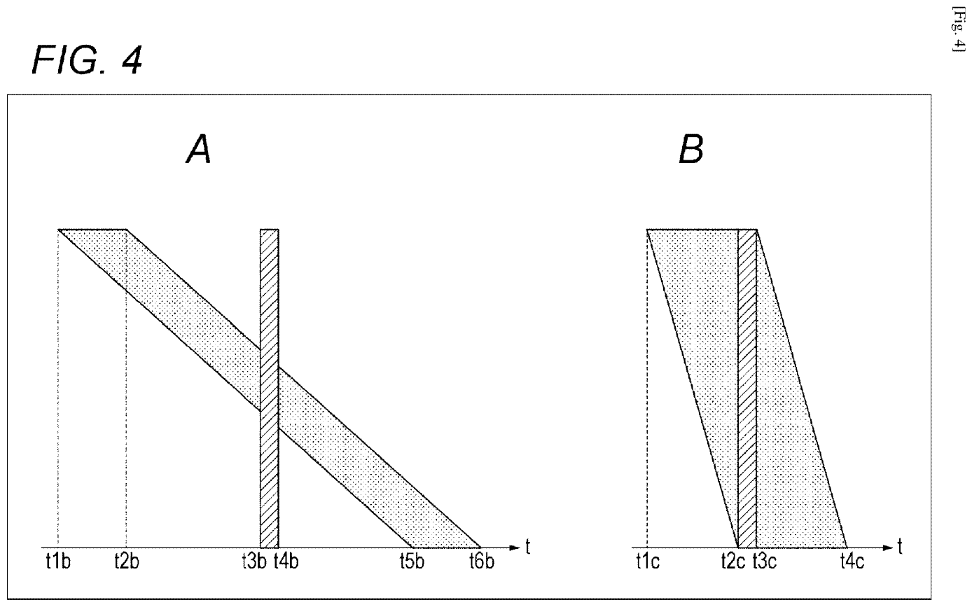

FIGS. 4A and 4B illustrates an example of a relationship between the exposure timing of the imaging element and the light emission timing of the illumination light in one frame period in a case where the camera includes the rolling shutter imaging element. In the drawing, a horizontal axis represents time, and a vertical axis represents a line of the imaging element.

In the example in FIG. 4A, for example, the exposure of a head line of the imaging element is performed in a period from time t1b to time t2b. Thereafter, the exposure of each line is sequentially performed from the second line to the last line of the imaging element while gradually shifting the time. Then, the exposure of the last line of the imaging element is performed in a period from time t5b to time t6b.

On the other hand, for example, in a period from time t3b to time t4b, the imaging range of the camera is irradiated with the illumination light.

In this case, the illumination light is emitted only during the exposure period of some pixels. Therefore, lateral stripes due to the illumination light are generated in a captured image.

On the other hand, for example, as illustrated in FIG. 4B, a frame rate of the imaging element is shortened, and the exposure period of each pixel is lengthened. Specifically, for example, the exposure of the head line of the imaging element is performed in a period from time t1c to time t3c. This exposure period is set longer than the exposure period in FIG. 4A. Thereafter, the exposure of each line is sequentially performed from the second line to the last line of the imaging element while gradually shifting the time. Then, the exposure of the last line of the imaging element is performed in a period from time t2c to time t4c. Note that the exposure of the last line is started at time t2c before time t3c at which the exposure of the head line ends.

On the other hand, for example, in a period from time t2c to time t3c, the imaging range of the camera is irradiated with the illumination light. That is, the illumination light is emitted in a period in which all the pixels of the imaging element are exposed. As a result, the imaging range of all the pixels of the imaging element is substantially uniformly irradiated with the illumination light.

In this example, since an irradiation period of the illumination light is shortened, power consumption by the illumination light is reduced.

On the other hand, the effect of the illumination light is reduced. That is, since the ratio of the irradiation period of the illumination light in the exposure period of each pixel becomes low, for example, in a scene irradiated with sunlight, the effect of the illumination light is hardly exhibited.

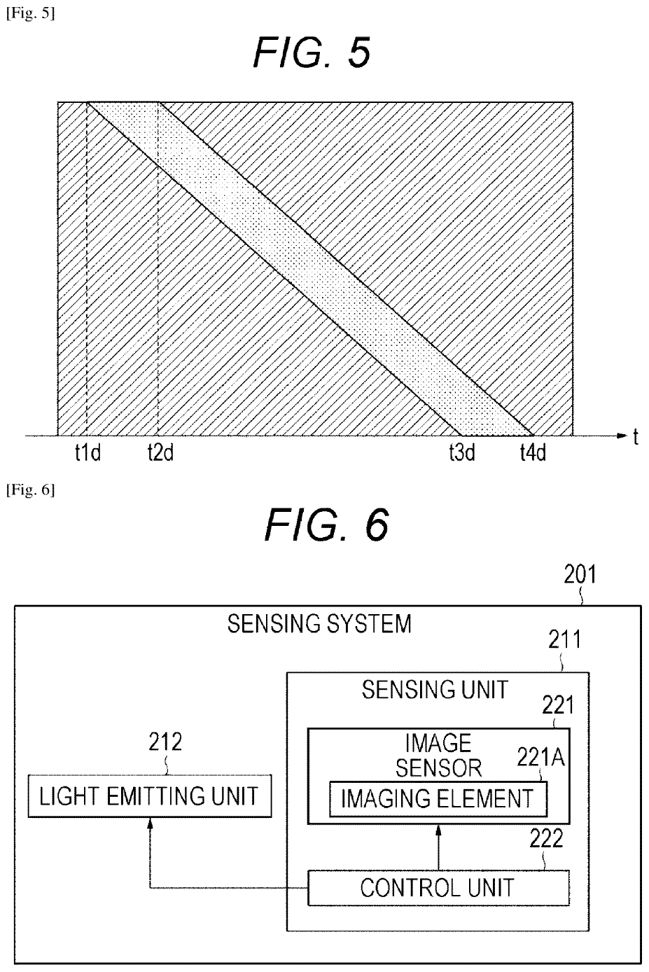

FIG. 5 illustrates another example of the relationship between the exposure timing of the imaging element and the light emission timing of the illumination light in one frame period in a case where the camera includes the rolling shutter imaging element. In the drawing, a horizontal axis represents time, and a vertical axis represents a line of the imaging element.

For example, the exposure of the head line of the imaging element is performed in a period from time t1d to time t2d. Thereafter, the exposure of each line is sequentially performed from the second line to the last line of the imaging element while gradually shifting the time. Then, the exposure of the last line of the imaging element is performed in a period from time t3d to time t4d.

On the other hand, for example, the imaging range of the camera is constantly irradiated with the illumination light. As a result, the imaging range of all the pixels of the imaging element is substantially uniformly irradiated with the illumination light.

In this example, the effect of the illumination light is improved. That is, since the ratio of the irradiation period of the illumination light in the exposure period of each pixel increases, for example, the effect of the illumination light is sufficiently exhibited even in a scene irradiated with sunlight.

On the other hand, since the irradiation period of the illumination light becomes long, power consumption by the illumination light becomes large.

On the other hand, the present technology is to improve utilization efficiency of a light emitting unit in a case where a rolling shutter image sensor is used. For example, the present technology improves an effect of the light emitting unit while suppressing power consumption of the light emitting unit.

### 3. First Embodiment

Next, a first embodiment of the present technology will be described with reference to FIGS. 6 to 9.

### <Configuration Example of Sensing System 201>

FIG. 6 illustrates a configuration example of a sensing system 201 to which the present technology is applied.

The sensing system 201 is applicable to the vehicle 1. The sensing system 201 includes a sensing unit 211 and a light emitting unit 212.

The sensing unit 211 includes an image sensor 221 and a control unit 222.

The image sensor 221 includes, for example, a rolling shutter imaging element 221A in which pixels including a light receiving element such as a photo diode (PD) are two-dimensionally arranged.

The control unit 222 integrally controls the image sensor 221 and the light emitting unit 212. For example, the control unit 222 integrally controls an imaging timing of the image sensor 221 and a light emission timing of the light emitting unit 212.

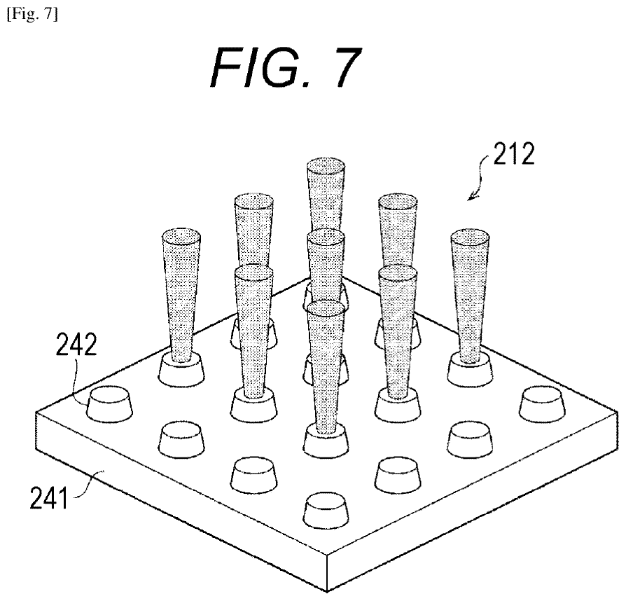

In the light emitting unit 212, for example, light emitting elements (light sources) are arranged two-dimensionally in a line direction (horizontal direction) and a column direction (vertical direction), and light emission can be controlled for each light emitting element. For example, as illustrated in FIG. 7, the light emitting unit 212 includes a vertical cavity surface emitting laser (VCSEL).

Specifically, the light emitting unit 212 includes a substrate 241 and a plurality of light emitting elements 242. The light emitting elements 242 are two-dimensionally arranged on the substrate 241. Each of the light emitting elements 242 emits laser light (Hereinafter, referred to as illumination light.) that is IR light in a direction perpendicular to the substrate 241.

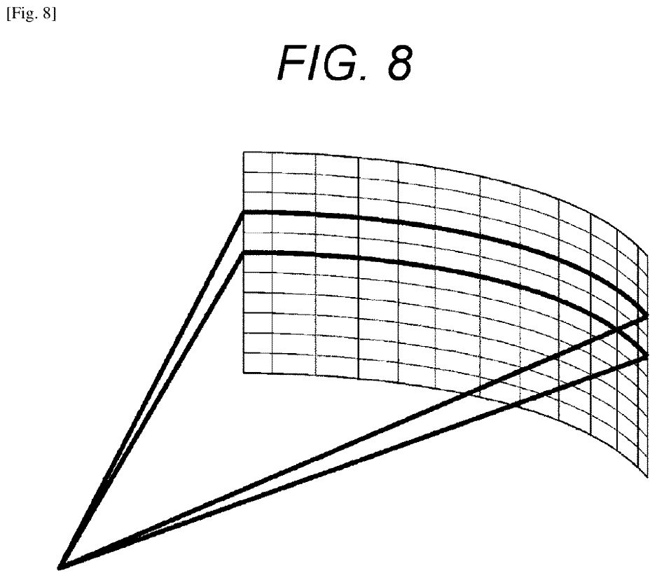

Thus, for example, as illustrated in FIG. 8, the light emitting unit 212 can scan the illumination light in the vertical direction, the illumination light extending in the line direction (horizontal direction).

The light emitting unit 212 emits the illumination light in an imaging direction of the image sensor 221. Therefore, the imaging range of the image sensor 221 and the irradiation range of the light emitting unit 212 at least partially overlap. Note that it is desirable that the irradiation range of the light emitting unit 212 is substantially the same as or includes the imaging range of the image sensor 221.

### <Operation Example of Sensing System 201>

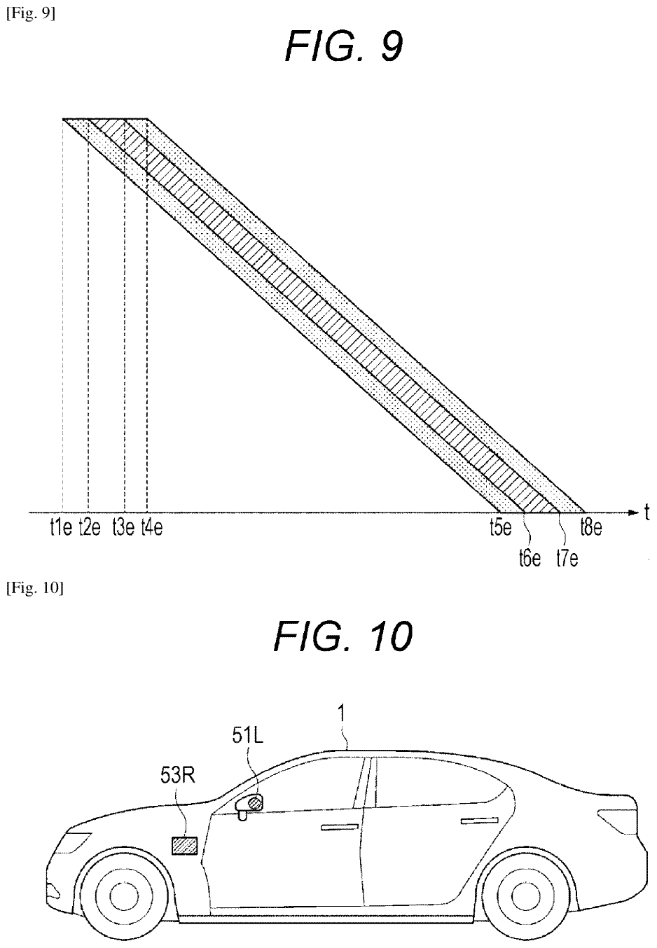

Next, an operation example of the sensing system 201 will be described with reference to a timing chart of FIG. 9. In FIG. 9, a horizontal axis represents time, and a vertical axis represents lines of the imaging element 221A and the light emitting unit 212.

For example, the exposure of the head line of the imaging element 221A is performed in a period from time t1e to time t4e. Thereafter, the exposure of each line is sequentially performed from the second line to the last line of the imaging element 221A while gradually shifting the time. Then, in a period from time t5e to time t8e, the exposure of the final line of the imaging element 221A is performed.

On the other hand, a light emission timing and an irradiation range of the light emitting unit 212 are controlled in accordance with an exposure timing of each line of the imaging element 221A. That is, the light emission timing of each line of the light emitting unit 212 is controlled in accordance with the exposure timing of each line of the imaging element 221A.

For example, in a period from time t2e to time t3e, the imaging range of the head line of the imaging element 221A is irradiated with the illumination light. That is, during a period of a predetermined length within the exposure period of the head line of the imaging element 221A, the imaging range of the head line of the imaging element 221A is irradiated with the illumination light.

Thereafter, the illumination light is sequentially applied to the imaging range of each line of the imaging element 221A from the imaging range of the second line to the imaging range of the last line of the imaging element 221A while shifting time little by little. Then, in a period from time t6e to time t7e, the imaging range of the last line of the imaging element 221A is irradiated with the illumination light.

In this manner, the imaging range of each line is irradiated with the illumination light in accordance with the exposure period of each line of the imaging element 221A.

As a result, in a case where the rolling shutter image sensor 221 is used, the utilization efficiency of the light emitting unit 212 can be improved. For example, while the light emission time of each line of the light emitting unit 212 is shortened, the time for irradiating the imaging range of each line with the illumination light can be lengthened in the exposure period of each line of the imaging element 221A. As a result, a light amount of illumination light for each line of the imaging element 221A is sufficiently secured, and power consumption of the light emitting unit 212 is reduced.

Note that, for example, the time t1e and the time t2e may be matched, and the time t5e and the time t6e may be matched. That is, the timing at which each line of the imaging element 221A starts exposure may be synchronized with the timing at which the irradiation of the illumination light is started for the imaging range of each line of the imaging element 221A.

Furthermore, for example, the time t3e and the time t4e may be matched, and the time t7e and the time t8e may be matched. That is, the timing at which the exposure of each line of the imaging element 221A ends may be synchronized with the timing at which the irradiation of the illumination light with respect to the imaging range of each line of the imaging element 221A ends.

Note that the number of lines of the imaging element 221A does not normally match the number of lines of the light emitting unit 212. Therefore, the imaging range of each line of the imaging element 221A does not normally coincide with the irradiation range of each line of the light emitting unit 212. Furthermore, the number of lines of the imaging element 221A is usually larger than the number of lines of the light emitting unit 212. Therefore, for example, it is assumed that the irradiation range of each line of the light emitting unit 212 includes imaging ranges of a plurality of the lines of the imaging element 221A.

In this case, for example, in the exposure period of each line of the imaging element 221A, the line of the light emitting unit 212 corresponding to each line of the imaging element 221A is controlled to emit light for a predetermined length of time. Here, the line of the light emitting unit 212 corresponding to each line of the imaging element 221A is, for example, a line whose irradiation range includes the imaging range of each line of the imaging element 221A. For example, in a case where the irradiation range of the head line of the light emitting unit 212 includes the imaging range of 1 to 10 lines of the imaging element 221A, the line of the light emitting unit 212 corresponding to 1 to 10 lines of the imaging element 221A is the head line of the light emitting unit 12.

Specifically, for example, the irradiation timing of each line of the light emitting unit 212 is controlled such that the irradiation period of the illumination light with respect to the imaging range of each line of the imaging element 221A becomes substantially the same. For example, the irradiation timing of each line of the light emitting unit 212 is controlled such that the irradiation period of each line of the light emitting unit 212 is included in the exposure period of the plurality of lines of the imaging element 221A corresponding to each line. For example, in a case where the head line of the light emitting unit 212 corresponds to lines 1 to 10 of the imaging element 221A, the irradiation timing of the head line of the light emitting unit 212 is controlled such that the irradiation period of the head line of the light emitting unit 212 is included in the exposure period of lines 1 to 10 of the imaging element 221A.

Note that, for example, the irradiation period of the light emitting unit 212 may include the exposure period of each line of the imaging element 221A. For example, in FIG. 9, the timing of starting exposure of each line of the imaging element 221A and the timing of starting light emission of each line of the light emitting unit 212 may be interchanged. Furthermore, for example, the timing at which the exposure of each line of the imaging element 221A ends and the timing at which the light emission of each line of the light emitting unit 212 ends may be interchanged.

Specifically, for example, the exposure of the head line of the imaging element 221A is performed in a period from time t2e to time t3e. Thereafter, the exposure of each line is sequentially performed from the second line to the last line of the imaging element 221A while gradually shifting the time. Then, in a period from time t6e to time t7e, the exposure of the final line of the imaging element 221A is performed.

On the other hand, for example, in a period from time t1e to time t4e, the imaging range of the head line of the imaging element 221A is irradiated with the illumination light. Thereafter, the illumination light is sequentially applied to the imaging range of each line of the imaging element 221A from the imaging range of the second line to the imaging range of the last line of the imaging element 221A while shifting time little by little. Then, in a period from time t5e to time t8e, the imaging range of the last line of the imaging element 221A is irradiated with the illumination light.

### 4. Second Embodiment

Next, a second embodiment of the present technology will be described with reference to FIGS. 10 to 14.

FIG. 10 illustrates an example of installation positions of a camera 51L and a LiDAR 53L of the vehicle 1.

The camera 51L is installed near a door mirror on the left side of the vehicle 1. The camera 51L includes, for example, an LED that emits illumination light including IR light, and captures an image while emitting the illumination light. An image of the camera 51L is used, for example, to check the left side when a driver parks the vehicle 1.

The LiDAR 53L is installed in front of the left side surface of the vehicle 1. The LiDAR 53L is used for monitoring the left front and the left side of the vehicle 1. The LiDAR 53L emits measurement light that is laser light including IR light, and receives reflected light of the measurement light, thereby sensing the left front side and the left side of the vehicle 1. For example, the LiDAR 53L detects the shape, distance, position, and the like of objects on the left front side and the left side of the vehicle 1.

In this case, when the illumination light from the camera 51L and the measurement light from the LiDAR 53L are simultaneously emitted, they interfere with each other. Therefore, it is necessary to control the camera 51L and the LiDAR 53L so as not to operate simultaneously. For example, when the vehicle 1 travels, the LiDAR 53L is turned on and the camera 51L is turned off. On the other hand, for example, when the vehicle 1 is parked, the camera 51L is turned on, and the LiDAR 53L is turned off.

On the other hand, for example, by integrating the camera and the LiDAR, sharing the light emitting unit for the camera and the light emitting unit for the LiDAR, and controlling the operation timing of each unit, the camera and the LiDAR can be operated at the same time.

<Configuration example of sensing system 301>

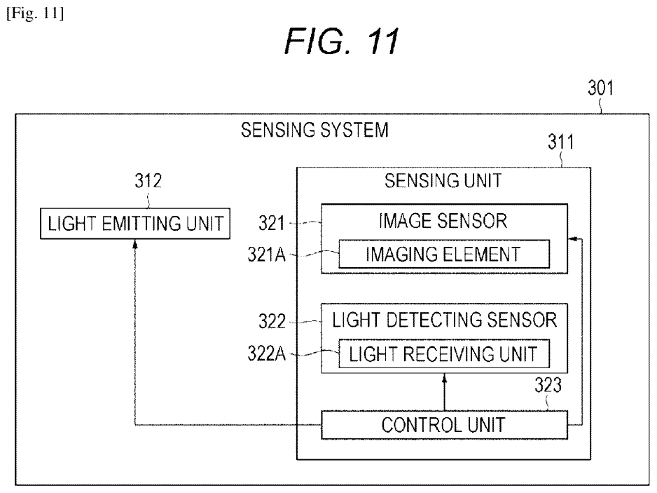

FIG. 11 illustrates a configuration example of a sensing system 301 to which the present technology is applied.

The sensing system 301 is a system in which a camera and a LiDAR are integrated, and can be applied to the vehicle 1. The sensing system 301 includes a sensing unit 311 and a light emitting unit 312.

The sensing unit 311 includes an image sensor 321, a light detecting sensor 322, and a control unit 323.

The image sensor 321 includes, for example, a rolling shutter imaging element 321A similarly to the imaging element 221A in FIG. 6.

The light detecting sensor 322 includes, for example, a light receiving unit 322A in which light receiving elements such as a single photon avalanche diode (SPAD) are two-dimensionally arranged. That is, in the light receiving unit 322A, a plurality of light receiving elements is arranged in a plurality of lines. The light receiving unit 322A receives reflected light of IR light emitted from the light emitting unit 312. The light detecting sensor 322 performs surrounding sensing on the basis of the reflected light received by the light receiving unit 322A. For example, the light detecting sensor 322 detects a shape, a distance, a position, and the like of a surrounding object.

The control unit 323 integrally controls the image sensor 321, the light detecting sensor 322, and the light emitting unit 312. For example, the control unit 323 integrally controls an imaging timing of the image sensor 321, a sensing timing of the light detecting sensor 322, and a light emission timing of the light emitting unit 312.

The light emitting unit 312 includes, for example, a VCSEL similarly to the light emitting unit 212 in FIG. 6, and light emitting elements are two-dimensionally arranged, and light emission can be controlled for each light emitting element. The IR light emitted from the light emitting unit 312 is used for both illumination light for the image sensor 321 and measurement light for the light detecting sensor 322.

The combination of the image sensor 321 and the light emitting unit 312 constitutes a camera with illumination. The combination of the light detecting sensor 322 and the light emitting unit 312 constitutes a LiDAR. That is, the sensing system 301 has two functions of the camera and the LiDAR.

The light emitting unit 312 emits the IR light in an imaging direction of the image sensor 321 and a sensing direction of the light detecting sensor 322. Therefore, the imaging range of the image sensor 321 and the sensing range of the light detecting sensor 322 at least partially overlap the irradiation range of the light emitting unit 312. Note that it is desirable that the irradiation range of the light emitting unit 312 is substantially the same as or includes a range obtained by combining the imaging range of the image sensor 321 and the sensing range of the light detecting sensor 322.

Note that the sensing range of the light detecting sensor 322 is, for example, a range (that is, a light receiving range of the light receiving unit 322A) in which the light receiving unit 322A can receive reflected light of the IR light.

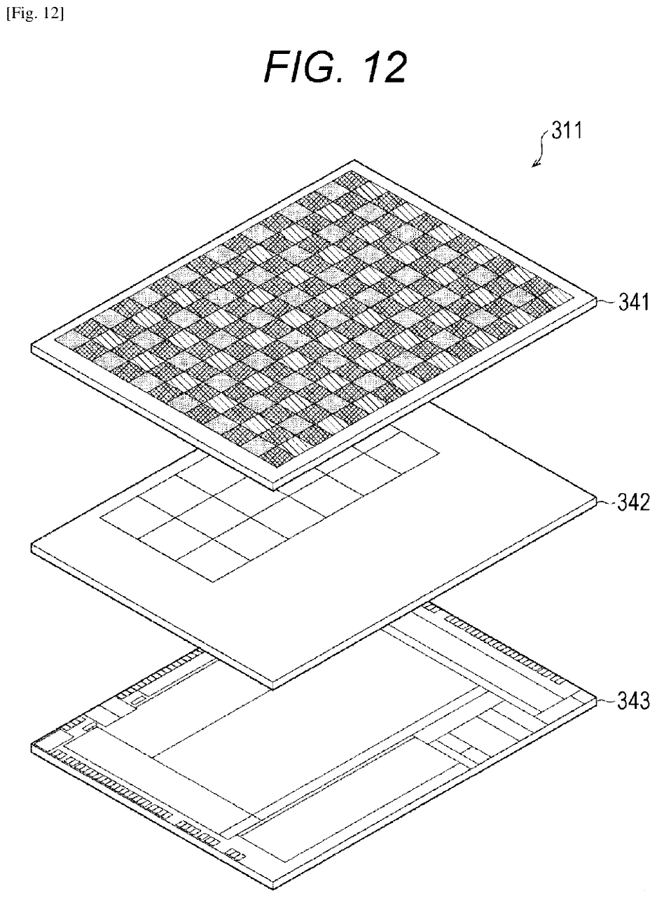

FIG. 12 illustrates a hardware configuration example of the sensing unit 311 of the sensing system 301.

The sensing unit 311 includes a module in which a chip 341 constituting the image sensor 321, a chip 342 constituting the light detecting sensor 322, and a chip 343 constituting the control unit 323 are stacked.

Thus, by modularizing the sensing unit 311, the sensing system 301 can be downsized.

### <Installation Example of Sensing System 301>

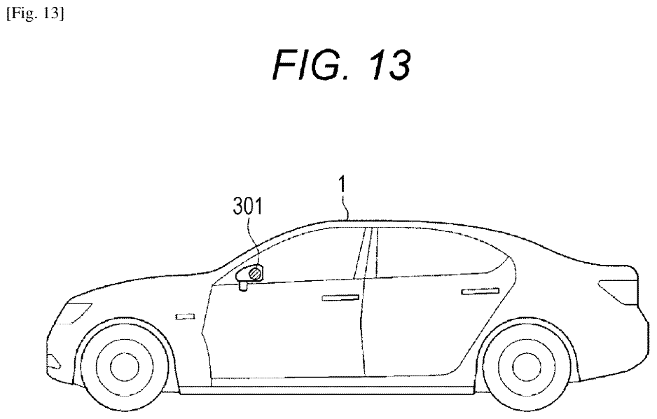

FIG. 13 illustrates an example of an installation position of the sensing system 301.

The sensing system 301 is installed, for example, near a door mirror on the left side surface of the vehicle 1.

### <Operation Example of Sensing System 301>

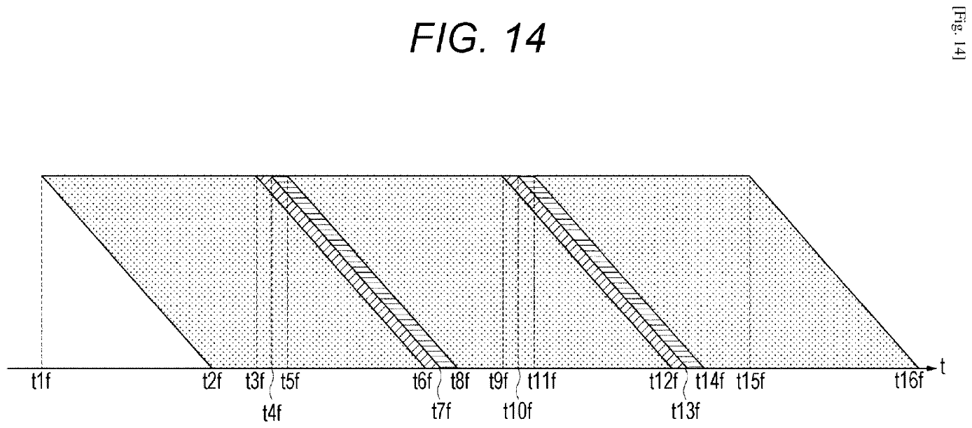

Next, an operation example of the sensing system 301 will be described with reference to a timing chart of FIG. 14. A horizontal axis in FIG. 14 indicates time. In FIG. 14, a vertical axis represents a line of the imaging element 321A, a line of the light receiving unit 322A, and a line of the light emitting unit 312.

For example, the exposure of the head line of the imaging element 321A is performed in a period from time t1f to time t3f. Thereafter, the exposure of each line is sequentially performed from the second line to the last line of the imaging element 321A while gradually shifting the time. Then, the exposure of the last line of the imaging element 321A is performed in a period from time t2f to time t6f.

Furthermore, in a period from time t3f to time t5f, the head line of the imaging element 321A is in a period in which the exposure is stopped (non-exposure period). The non-exposure period includes a reading period in which pixel signals are read. Thereafter, the non-exposure period is sequentially set while shifting the time gradually from the second line to the last line of the imaging element 321A. Then, in a period from time t6f to time t8f, the last line of the imaging element 321A is in a non-exposure period.

Next, in a period from time t5f to time t9f, the exposure of the head line of the next frame of the imaging element 321A is performed. Thereafter, the exposure of each line is sequentially performed from the second line to the last line of the imaging element 321A while gradually shifting the time. Then, in a period from time t8f to time t12f, the exposure of the final line of the imaging element 321A is performed.

Then, the light emitting unit 312 emits light in a predetermined pattern in each of the exposure period and the non-exposure period of the imaging element 321A.

For example, during the exposure period of the imaging element 321A, the light emitting unit 312 does not emit light in a bright state around the vehicle 1 such as daytime.

For example, during the exposure period of the imaging element 321A, the light emitting unit 312 emits light in a dark state around the vehicle 1 such as at night. At this time, similarly to the method described above with reference to FIG. 9, each line of the light emitting unit 312 emits light in accordance with the exposure period of each line of the imaging element 321A. As a result, during the exposure period of each line of the imaging element 321A, the imaging range of each line is irradiated with the illumination light for a predetermined length of time.

On the other hand, LiDAR processing is executed in a non-exposure period of the imaging element 321A.

Specifically, for example, in a period from time t3f to time t4f, light emission of the head line of the light emitting unit 312 is performed for the light detecting sensor 322. Thereafter, for the light detecting sensor 322, the light emission of each line is sequentially performed from the second line to the last line of the light emitting unit 312 while shifting the time little by little. Then, in a period from time t6f to time t7f, the light emission of the final line of the light emitting unit 312 is performed for the light detecting sensor 322.

In this manner, the light emission timing of the light emitting unit 312 is controlled for each line in accordance with the non-exposure period for each line of the imaging element 321A.

Furthermore, for example, in a period from time t4f to time t5f, light reception, distance measurement, and the like of the head line of the light receiving unit 322A are performed. Thereafter, the light reception, distance measurement, and the like of each line from the second line to the last line of the light receiving unit 322A are sequentially performed while shifting the time little by little. Then, in a period from time t7f to time t8f, the light reception, distance measurement, and the like of the last line of the light emitting unit 312 are performed.

Hereinafter, after time t9f, the processing from time t3f to time t8f described above is repeatedly executed.

Note that, in the example of FIG. 14, light emission for the light detecting sensor 322 is started immediately after the end of the exposure period of the imaging element 321A. However, the light emission may be started after a slight interval.

Furthermore, for example, in a case where the sensing range of the light detecting sensor 322 is narrower than the irradiation range of the IR light of the light emitting unit 312, it is not always necessary to cause all the light emitting elements of the light emitting unit 312 to emit light.

Moreover, the light detecting sensor 322 can execute processing even when the light receiving elements of the light receiving unit 322A receive light at the same time. Therefore, for example, in a case where there is an interval between the end of the exposure of the last line of the imaging element 321A and the start of the exposure of the head of the imaging element 321A, that is, in a case where there is an interval between the end of the exposure of the previous frame of the imaging element 321A and the start of the exposure of the next frame, it is also possible to have a plurality of lines of the light emitting unit 312 emit light simultaneously and all lines of the light receiving unit 322A receive the light simultaneously in the interval.

As described above, in a case where the rolling shutter image sensor 321 is used, the utilization efficiency of the light emitting unit 312 can be improved.

For example, one light emitting unit 312 can be shared in the camera and LiDAR function. Accordingly, the sensing system 301 can be downsized. Furthermore, the camera and the LiDAR can be integrated into one system, and the degree of freedom of the installation position is improved.

For example, the light emission time of each line of the light emitting unit 312 can be suppressed to a range necessary for the camera and LiDAR function. As a result, power consumption of the light emitting unit 312 is reduced.

### 5. Third Embodiment

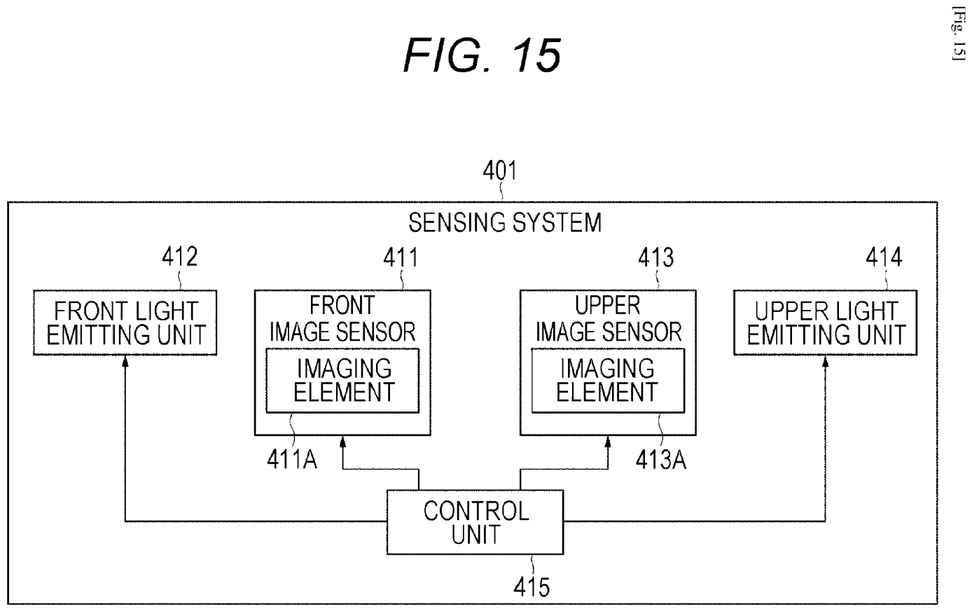

Next, a third embodiment of the present technology will be described with reference to FIGS. 15 to 17.

### <Configuration Example of Sensing System 401>

FIG. 15 illustrates a configuration example of a sensing system 401 to which the present technology is applied.

The sensing system 401 is applicable to the vehicle 1. The sensing system 401 includes a front image sensor 411, a front light emitting unit 412, an upper image sensor 413, an upper light emitting unit 414, and a control unit 415.

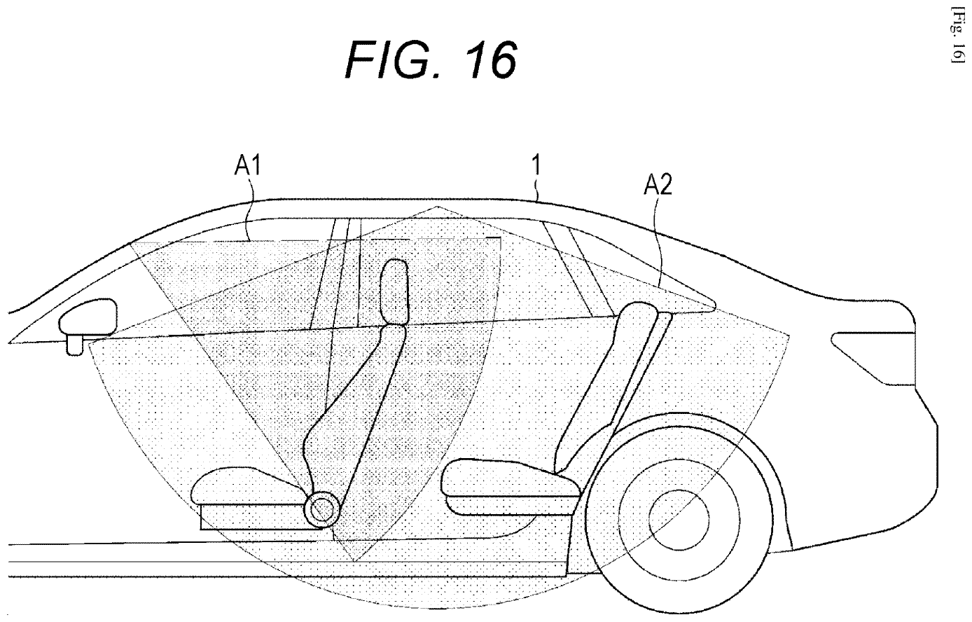

Similarly to the imaging element 221A of FIG. 6, the front image sensor 411 includes a rolling shutter imaging element 411A. The front image sensor 411 is installed, for example, in an upper front portion (for example, near the rear-view mirror) of the vehicle 1. For example, the front image sensor 411 images an imaging range A1 in FIG. 16. That is, the front image sensor 411 images the vicinity of the occupants in the driver seat and the passenger seat of the vehicle 1. An image captured by the front image sensor 411 is used for, for example, the DMS, an occupant monitoring system (OMS), and a video chat.

The front light emitting unit 412 is installed at substantially the same position as the front image sensor 411. The front light emitting unit 412 includes a VCSEL, similarly to the light emitting unit 212 in FIG. 6. An irradiation range of illumination light of the front light emitting unit 412 at least partially overlaps with the imaging range A1. Note that it is desirable that the irradiation range of the front light emitting unit 412 is substantially the same as the imaging range A1 or includes the imaging range A1.

Similarly to the imaging element 221A of FIG. 6, the upper image sensor 413 includes a rolling shutter imaging element 413A. The upper image sensor 413 is installed, for example, at the upper center of the vehicle 1 (for example, in the vicinity of the center of the ceiling in the vehicle). For example, the upper image sensor 413 images an imaging range A2 in FIG. 16. That is, the upper image sensor 413 images the entire inside of the vehicle from above.

An image captured by the upper image sensor 413 is used, for example, to detect the leaving of a child or the like in the vehicle.

The upper light emitting unit 414 is installed at substantially the same position as the upper image sensor 413. Similarly to the light emitting unit 212 in FIG. 6, the upper light emitting unit 414 includes a VCSEL. An irradiation range of illumination light of the upper light emitting unit 414 at least partially overlaps with the imaging range A2. Note that it is desirable that the irradiation range of the upper light emitting unit 414 is substantially the same as the imaging range A2 or includes the imaging range A2.

The control unit 415 integrally controls the front image sensor 411, the front light emitting unit 412, the upper image sensor 413, and the upper light emitting unit 414. For example, the control unit 415 integrally controls an exposure timing of the front image sensor 411, a light emission timing of the front light emitting unit 412, an exposure timing of the upper image sensor 413, and a light emission timing of the upper light emitting unit 414.

### <Operation Example of Sensing System 401>

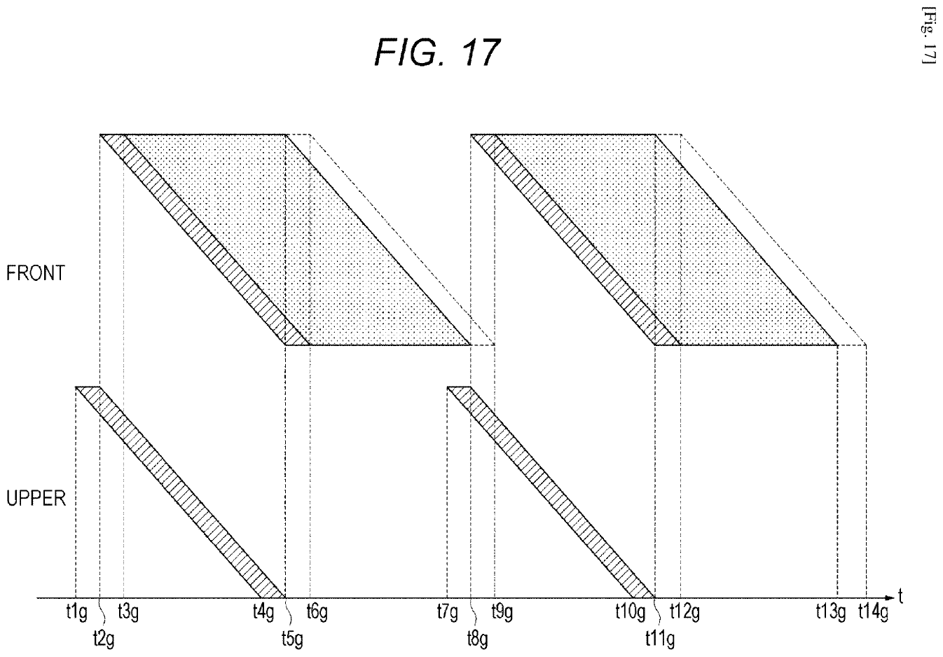

Next, an operation of the sensing system 401 will be described with reference to a timing chart of FIG. 17. An upper part of FIG. 17 illustrates the operation of the front image sensor 411, and a lower part illustrates the operation of the upper image sensor 413. A horizontal axis in FIG. 17 indicates time. A vertical axis in the upper part of FIG. 17 indicates a line of the imaging element 411A of the front image sensor 411. The vertical axis in the lower part of FIG. 17 indicates a line of the imaging element 413A of the upper image sensor 413.

For example, in a period from time t1g to time t2g, the exposure of the head line of the imaging element 413A of the upper image sensor 413 is performed. Thereafter, the exposure of each line is sequentially performed from the second line to the last line of the imaging element 413A while gradually shifting the time. Then, the exposure of the last line of the imaging element 413A is performed in a period from time t4g to time t5g.

At this time, similarly to the method described above with reference to FIG. 9, each line of the upper light emitting unit 414 emits light in accordance with the exposure period of each line of the imaging element 413A. As a result, during the exposure period of each line of the imaging element 413A, the imaging range of each line is irradiated with the illumination light for a predetermined length of time.

In this manner, in accordance with a non-exposure period of each line of the front image sensor 411, each line of the upper light emitting unit 414 emits light, and each line of the upper image sensor 413 is exposed.

Next, in a period from time t2g to time t3g, the exposure of the head line of the imaging element 411A of the front image sensor 411 is performed for the first DMS and OMS. Thereafter, for the first DMS and OMS, the exposure of each line is sequentially performed from the second line to the last line of the imaging element 411A while gradually shifting the time. Then, in a period from time t5g to time t6g, the exposure of the final line of the imaging element 411A is performed for the first DMS and OMS.

At this time, similarly to the method described above with reference to FIG. 9, each line of the front light emitting unit 412 emits light in accordance with the exposure period of each line of the imaging element 411A. As a result, during the exposure period of each line of the imaging element 411A, the imaging range of each line is irradiated with the illumination light for a predetermined length of time.

Next, in a period from time t3g to time t5g, the exposure of the head line of the imaging element 411A of the front image sensor 411 is performed for the video chat. Thereafter, the exposure of each line is sequentially performed from the second line to the last line of the imaging element 411A for the video chat while gradually shifting the time. Then, in a period from time t6g to time t8g, the final line of the imaging element 411A is exposed for the video chat.

Note that, for example, in an exposure period for the video chat of the imaging element 411A, the front light emitting unit 412 does not emit light in a bright state around the vehicle 1 such as daytime.

On the other hand, for example, in an exposure period for the video chat of the imaging element 411A, the front light emitting unit 412 emits light in a dark state around the vehicle 1 such as at night. At this time, similarly to the method described above with reference to FIG. 9, each line of the front light emitting unit 412 emits light in accordance with the exposure period of each line of the imaging element 411A. As a result, during the exposure period of each line of the imaging element 411A, the imaging range of each line is irradiated with the illumination light for a predetermined length of time.

Note that, although not illustrated, a predetermined interval is provided for a readout period or the like between the exposure period of each line of the imaging element 411A for the first DMS and OMS and the exposure period of each line of the imaging element 411A for the video chat.

Next, in a period from time t5g to time t6g, the exposure of the head line of the imaging element 411A of the front image sensor 411 is performed for the second DMS and OMS. Thereafter, for the second DMS and OMS, the exposure of each line is sequentially performed from the second line to the last line of the imaging element 411A while gradually shifting the time. Then, in a period from time t8g to time t9g, the exposure of the final line of the imaging element 411A is performed for the second DMS and OMS.

Note that, during the second exposure period for the DMS and OMS, the front light emitting unit 412 does not emit light.

Note that, although not illustrated, a predetermined interval is provided for a readout period or the like between the exposure period of each line of the imaging element 411A for the video chat and the exposure period of each line of the imaging element 411A for the second DMS and OMS.

Then, a difference between an image for the first DMS and OMS captured by the front image sensor 411 in a state of being irradiated with the illumination light and an image for the second DMS and OMS captured by the front image sensor 411 in a state of not being irradiated with the illumination light is taken. As a result, the influence of ambient light is removed from the image for the DMS and OMS.

In this manner, in accordance with the non-exposure period of each line of the upper image sensor 413, each line of the front light emitting unit 412 emits light, and each line of the front image sensor 411 is exposed.

Next, in a period from time t8g to time t9g, the exposure of the head line of the next frame of the imaging element 413A of the upper image sensor 413 is performed.

Thereafter, after time t8g, the processing from time t1g to time t9g described above is repeatedly executed.

Note that an interval may be provided between the exposure period of each line of the front image sensor 411 and the exposure period of each line of the upper image sensor 413.

As described above, similarly to the first embodiment described above, in a case where the rolling shutter front image sensor 411 and upper image sensor 413 are used, the utilization efficiency of the front light emitting unit 412 and the upper light emitting unit 414 can be improved.

Furthermore, the exposure timing of the front image sensor 411, the light emission timing of the front light emitting unit 412, the exposure timing of the upper image sensor 413, and the light emission timing of the upper light emitting unit 414 are appropriately controlled. For example, the light emission timing of the front light emitting unit 412 is controlled so that the illumination light of the front light emitting unit 412 does not affect the exposure (imaging) of each line of the upper image sensor 413. For example, the light emission timing of the upper light emitting unit 414 is controlled so that the illumination light of the upper light emitting unit 414 does not affect the exposure (imaging) of each line of the front image sensor 411.

Note that, in the DMS, OMS, and video chat, since the motion of the subject is small, adverse effects due to rolling shutter distortion hardly occur.

### 6. Modification Example

Hereinafter, modification examples of the above-described embodiments of the present technology will be described.

For example, the light emitting elements of the respective lines of the light emitting unit do not necessarily all need to emit light at the same time. For example, the light emitting elements of each line may be thinned out as necessary to emit light. For example, in a case where light is emitted for the LiDAR, it is also possible to scan the light emitting element of each line in the horizontal direction.

For example, in the present technology, it is also possible to use a light emitting unit that mechanically scans light in the vertical direction (column direction) using a mirror or the like.

For example, in the present technology, it is also possible to use a light emitting unit in which light emitting elements are one-dimensionally arranged. For example, it is also possible to use a light emitting unit in which one light emitting element is provided in each line. For example, it is possible to use a light emitting unit in which a plurality of light emitting elements is arranged in one line and light emitted from the line is mechanically scanned in the vertical direction.

In the above description, an example in which the light emitting unit emits the IR light has been described, but a wavelength of light emitted by the light emitting unit is not particularly limited. For example, visible light or the like is used as necessary.

For example, the rolling shutter imaging element used in the present technology includes not only an imaging element that exposes (scans) each line but also an imaging element that exposes (scans) each of a plurality of lines.

In the above description, an example has been described in which the light emission timing of each line of the light emitting unit is controlled in accordance with the exposure timing of each line of the image sensor. However, the exposure timing of each line of the image sensor may be controlled in accordance with the light emission timing of each line of the light emitting unit.

In addition to the LiDAR described above, the present technology can also be applied to a case where an imaging element is combined with a sensor capable of sharing an imaging element and a light emitting unit.

For example, the present technology can be applied to a system or a device including an image sensor including a rolling shutter imaging element in addition to a vehicle. For example, the present technology can also be applied to a moving body other than a vehicle. For example, the present technology can be applied to a monitoring system that monitors a predetermined area such as a building. For example, the present technology can be applied to an information processing device such as a smartphone.

### 7. Others

In the present specification, the system means a set of a plurality of components (devices, modules (parts), and the like), and it does not matter whether all the components are located in the same housing or not. Therefore, a plurality of devices housed in separate housings and connected via a network, and a single device with a plurality of modules housed in one housing are both systems.

Moreover, the embodiments of the present technology are not limited to the above-described embodiments, and various modifications can be made without departing from the gist of the present technology.

For example, the present technology may be configured as cloud computing in which a function is shared by a plurality of devices through the network to process together.

### <Combination Examples of Configurations>

The present technology can also employ the following configurations:
(1)
   A sensing system comprising: a first imaging sensor including an array of light receiving elements; a first light emitter including an array of light emitting elements; and control circuitry configured to control the first imaging sensor and the first light emitter such that an imaging range of a subset of the array of light receiving elements overlaps with an irradiation range of a subset of the array of light emitting elements.
(2)
   The sensing system according to (1), wherein the subset of the array of light receiving elements is a number of lines in the array of light receiving elements, and the subset of the array of light emitting elements is a same number of lines in the array of light emitting elements.
(3)
   The sensing system according to (2), wherein the number of lines is 1.
(4)
   The sensing system according to (1), wherein the control circuitry controls an exposure timing of the first imaging sensor based upon a light emission timing of the first light emitter.
(5)
   The sensing system according to (2), wherein the control circuitry controls a light emission timing of the first light emitter based upon an exposure timing of the first imaging sensor.
(6)
   The sensing system according to (5), wherein the control circuitry controls the light emission timing of each line of the array of light emitting elements to correlate to the exposure timing of each line of the array of light receiving elements.
(7)
   The sensing system according to (6), wherein the control circuitry causes each line of the array of light emitting elements to emit light for a predetermined period of time in an exposure period of each line of the array of light receiving elements.
(8)
   The sensing system according to (1), further comprising: a light detecting sensor including an array of light receiving elements, wherein the control circuitry is configured to control the first light emitter to emit light in a first pattern for the light detecting sensor in a non-exposure period that is a period other than an exposure period of the first imaging sensor.
(9)
   The sensing system according to (8), wherein the control circuitry controls a light emission timing of each line of the array of light emitting elements in accordance with the non-exposure period for each line of the array of light receiving elements in the first imaging sensor.
(10)
   The sensing system according to (8), wherein the control circuitry causes a plurality of lines of the array of light emitting elements to simultaneously emit light in the non-exposure period of the first imaging sensor.
(11)
   The sensing system according to (8), wherein the control circuitry causes the first light emitter to emit light in a second pattern in the exposure period of the first imaging sensor.
(12)
   The sensing system according to (8), wherein the other array of light receiving elements of the light detecting sensor receives reflected light of light emitted by the first light emitter.
(13)
   The sensing system according to (8), wherein the first imaging sensor, the light detecting sensor, and the control circuitry are provided in a same chip assembly.
(14)
   The sensing system according to (1), further comprising: a second rolling shutter imaging sensor that includes an array of light receiving elements; and a second light emitter that includes an array of light emitting elements, wherein the control circuitry is configured to control the second imaging sensor and the second light emitter such that an imaging range of a subset of the array of light receiving elements of the second imaging sensor overlaps with an irradiation range of a subset of the array of light emitting elements of the second light emitter.
(15)
   The sensing system according to (14), wherein the control circuitry causes the second imaging sensor to be exposed and causes the second light emitter to emit light in a non-exposure period that is a period other than an exposure period of the first imaging sensor.
(16)
   The sensing system according to (15), wherein the control circuitry causes each line of the array of light receiving elements of the second imaging sensor to be exposed and causes each line of the array of light emitting elements of the second light emitter to emit light in accordance with the non-exposure period of each line of the first imaging sensor.
(17)
   The sensing system according to (16), wherein the control circuitry causes the first imaging sensor to be exposed and causes the first light emitter to emit light in the non-exposure period of the second imaging sensor.
(18)
   The sensing system according to (17), wherein the control circuitry causes each line of the array of light receiving elements of the first imaging sensor to be exposed and causes each line of the array of light emitting elements of the first light emitter to emit light in accordance with the non-exposure period of each line of the second imaging sensor.
(19)
   The sensing system according to (1), wherein the first imaging sensor, the first light emitter, and the control circuitry are provided in a vehicle.
(20)
   A sensing control device comprising: control circuitry configured to control a first imaging sensor that includes an array of light receiving elements, and to control a first light emitter that includes an array of light emitting elements, wherein an imaging range of a subset of the array of light receiving elements of the first imaging sensor overlaps with an irradiation range of a subset of the array of light emitting elements of the first light emitter.
(21)
   A sensing method comprising: controlling a first imaging sensor that includes an array of light receiving elements; and controlling a first light emitter that includes an array of light emitting elements, wherein
      an imaging range of a subset of the array of light receiving elements of the first imaging sensor overlaps with an irradiation range of a subset of the array of light emitting elements of the first light emitter.
(22)
   A non-transitory computer readable medium storing program code, the program code being executable to perform operations comprising: controlling a first imaging sensor that includes an array of light receiving elements; and controlling a first light emitter that includes an array of light emitting elements, wherein
      an imaging range of a subset of the array of light receiving elements of the first imaging sensor overlaps with an irradiation range of a subset of the array of light emitting elements of the first light emitter.
(B1)
   A sensing system including:
      a first image sensor that controls exposure for each line;
      a first light emitting unit whose irradiation range overlaps at least a part of an imaging range of the first image sensor and whose light emission timing can be controlled for each line; and
      a control unit that integrally controls the first image sensor and the first light emitting unit.
(B2)
   The sensing system according to (B1), in which
      the control unit controls one of an exposure timing of the first image sensor and a light emission timing of the first light emitting unit on the basis of the other.
(B3)
   The sensing system according to (B2), in which
      the control unit controls one of an exposure timing of each line of the first image sensor and a light emission timing of each line of the first light emitting unit in accordance with the other.
(B4)
   The sensing system according to (B3), in which
      the control unit causes a line of the first light emitting unit corresponding to each line of the first image sensor to emit light for a period of a predetermined length in an exposure period of each line of the first image sensor.
(B5)
   The sensing system according to (B1), further including
      a light detecting sensor in which a plurality of light receiving elements is arranged in a plurality of lines.
      in which the control unit causes the first light emitting unit to emit light in a first pattern for the light detecting sensor in a non-exposure period that is a period other than an exposure period of the first image sensor.
(B6)
   The sensing system according to (B5), in which
      the control unit controls a light emission timing of the first light emitting unit for each line in accordance with the non-exposure period for each line of the first image sensor.
(B7)
   The sensing system according to (B5), in which
      the control unit causes a plurality of lines of the first light emitting unit to simultaneously emit light in the non-exposure period of the first image sensor.
(B8)
   The sensing system according to any one of (B5) to (B7), in which
      the control unit causes the first light emitting unit to emit light in a second light emission pattern in the exposure period of the first image sensor.
(B9)
   The sensing system according to any one of (B5) to (B8), in which
      each of the light receiving elements of the light detecting sensor receives reflected light of light emitted by the first light emitting unit.
(B10)
   The sensing system according to any one of (5) to (9), in which
      the first image sensor, the light detecting sensor, and the control unit are provided in one module.
(B11)
   The sensing system according to (B1), further including:
      a second image sensor that controls exposure for each line; and
      a second light emitting unit whose irradiation range overlaps at least a part of an imaging range of the second image sensor and whose light emission timing can be controlled for each line,
      in which the control unit integrally controls the first image sensor, the first light emitting unit, the second image sensor, and the second light emitting unit.
(B12)
   The sensing system according to (B11), in which
      the control unit causes the second image sensor to be exposed and causes the second light emitting unit to emit light in a non-exposure period that is a period other than an exposure period of the first image sensor.
(B13)
   The sensing system according to (B12), in which
      the control unit causes each line of the second image sensor to be exposed and causes each line of the second light emitting unit to emit light in accordance with the non-exposure period of each line of the first image sensor.
(B14)
   The sensing system according to (B13), in which
      the control unit causes the first image sensor to be exposed and causes the first light emitting unit to emit light in the non-exposure period of the second image sensor.
(B15)
   The sensing system according to (B14), in which
      the control unit causes each line of the first image sensor to be exposed and causes each line of the first light emitting unit to emit light in accordance with the non-exposure period of each line of the second image sensor.
(B16)
   The sensing system according to any one of (B1) to (B15), in which
      the first image sensor, the first light emitting unit, and the control unit are provided in a vehicle.
(B17)
   A sensing control device including
      a control unit that integrally controls a first image sensor that controls exposure for each line and a light emitting unit whose irradiation range overlaps at least a part of the imaging range of the image sensor and whose light emission timing can be controlled for each line.
(B18)
   A sensing method including
      integrally controlling a first image sensor that controls exposure for each line and a light emitting unit whose irradiation range overlaps at least a part of an imaging range of the image sensor and whose light emission timing can be controlled for each line.

Note that the effects described in the present specification are merely examples and are not limited, and other effects may be provided.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Vehicle
11 Vehicle control system
51 Camera
53 LiDAR
201 Sensing system
211 Sensing unit
212 Light emitting unit
221 Image sensor
221A Imaging element
222 Control unit
301 Sensing system
311 Sensing unit
312 Light emitting unit
321 Image sensor
321A Imaging element
322 Light detecting sensor
322A Light receiving unit
323 Control unit
341 to 343 Chip
401 Sensing system
411 Front image sensor
411A Imaging element
412 Front light emitting unit
413 Upper image sensor
413A Imaging element
414 Upper light emitting unit
415 Control unit

1. A sensing system comprising:
a first imaging sensor including an array of light receiving elements;
a first light emitter including an array of light emitting elements; and
control circuitry configured to control the first imaging sensor and the first light emitter such that an imaging range of a subset of the array of light receiving elements overlaps with an irradiation range of a subset of the array of light emitting elements.

2. The sensing system according to claim 1, wherein the subset of the array of light receiving elements is a number of lines in the array of light receiving elements, and the subset of the array of light emitting elements is a same number of lines in the array of light emitting elements.

3. The sensing system according to claim 2, wherein the number of lines is 1.

4. The sensing system according to claim 1, wherein the control circuitry controls an exposure timing of the first imaging sensor based upon a light emission timing of the first light emitter.

5. The sensing system according to claim 2, wherein the control circuitry controls a light emission timing of the first light emitter based upon an exposure timing of the first imaging sensor.

6. The sensing system according to claim 5, wherein the control circuitry controls the light emission timing of each line of the array of light emitting elements to correlate to the exposure timing of each line of the array of light receiving elements.

7. The sensing system according to claim 6, wherein the control circuitry causes each line of the array of light emitting elements to emit light for a predetermined period of time in an exposure period of each line of the array of light receiving elements.

8. The sensing system according to claim 1, further comprising:
a light detecting sensor including an array of light receiving elements, wherein the control circuitry is configured to control the first light emitter to emit light in a first pattern for the light detecting sensor in a non-exposure period that is a period other than an exposure period of the first imaging sensor.

9. The sensing system according to claim 8, wherein the control circuitry controls a light emission timing of each line of the array of light emitting elements in accordance with the non-exposure period for each line of the array of light receiving elements in the first imaging sensor.

10. The sensing system according to claim 8, wherein the control circuitry causes a plurality of lines of the array of light emitting elements to simultaneously emit light in the non-exposure period of the first imaging sensor.

11. The sensing system according to claim 8, wherein the control circuitry causes the first light emitter to emit light in a second pattern in the exposure period of the first imaging sensor.

12. The sensing system according to claim 8, wherein the other array of light receiving elements of the light detecting sensor receives reflected light of light emitted by the first light emitter.

13. The sensing system according to claim 8, wherein the first imaging sensor, the light detecting sensor, and the control circuitry are provided in a same chip assembly.

14. The sensing system according to claim 1, further comprising:
a second imaging sensor that includes an array of light receiving elements; and
a second light emitter that includes an array of light emitting elements, wherein the control circuitry is configured to control the second imaging sensor and the second light emitter such that an imaging range of a subset of the array of light receiving elements of the second imaging sensor overlaps with an irradiation range of a subset of the array of light emitting elements of the second light emitter.

15. The sensing system according to claim 14, wherein
the control circuitry causes the second imaging sensor to be exposed and causes the second light emitter to emit light in a non-exposure period that is a period other than an exposure period of the first imaging sensor.

16. The sensing system according to claim 15, wherein
the control circuitry causes each line of the array of light receiving elements of the second imaging sensor to be exposed and causes each line of the array of light emitting elements of the second light emitter to emit light in accordance with the non-exposure period of each line of the first imaging sensor.

17. The sensing system according to claim 16, wherein
the control circuitry causes the first imaging sensor to be exposed and causes the first light emitter to emit light in the non-exposure period of the second imaging sensor.

18. The sensing system according to claim 17, wherein
the control circuitry causes each line of the array of light receiving elements of the first imaging sensor to be exposed and causes each line of the array of light emitting elements of the first light emitter to emit light in accordance with the non-exposure period of each line of the second imaging sensor.

19. The sensing system according to claim 1, wherein
the first imaging sensor, the first light emitter, and the control circuitry are provided in a vehicle.

20. A sensing control device comprising:
control circuitry configured to control a first imaging sensor that includes an array of light receiving elements, and to control a first light emitter that includes an array of light emitting elements, wherein
an imaging range of a subset of the array of light receiving elements of the first imaging sensor overlaps with an irradiation range of a subset of the array of light emitting elements of the first light emitter.

21. A sensing method comprising:
controlling a first imaging sensor that includes an array of light receiving elements; and
controlling a first light emitter that includes an array of light emitting elements, wherein
an imaging range of a subset of the array of light receiving elements of the first imaging sensor overlaps with an irradiation range of a subset of the array of light emitting elements of the first light emitter.

22. A non-transitory computer readable medium storing program code, the program code being executable to perform operations comprising:
controlling a first imaging sensor that includes an array of light receiving elements; and
controlling a first light emitter that includes an array of light emitting elements, wherein
an imaging range of a subset of the array of light receiving elements of the first imaging sensor overlaps with an irradiation range of a subset of the array of light emitting elements of the first light emitter.
